(19) United States
(12) Patent Application Publication
(10) Pub. No.: US 2011/0023083 A1
(43) Pub. Date: Jan. 27, 2011

(54) METHOD AND APPARATUS FOR DIGITAL RIGHTS MANAGEMENT FOR USE IN MOBILE COMMUNICATION TERMINAL

(75) Inventors: Hyeonsang Eom, Seoul (KR); Hoseop Lee, Seoul (KR); Sunghwan Jung, Seoul (KR); Gun-wook Kim, Goyang-si (KR); So-young Jeong, Seoul (KR); Kyung Park, Daejeon-si (KR)

Correspondence Address: H.C. PARK & ASSOCIATES, PLC, 8500 LEESBURG PIKE, SUITE 7500, VIENNA, VA, 22182, US

(73) Assignees: PANTECH CO., LTD., Seoul (KR); PANTECH&CURITEL COMMUNICATIONS, INC., Seoul (KR); SEOUL NATIONAL UNIVERSITY INDUSTRY FOUNDATION, Seoul (KR)

(21) Appl. No.: 12/530,283

(22) PCT Filed: Mar. 6, 2008
(86) PCT No.: PCT/KR2008/001266

§ 371 Date: Apr. 20, 2010

(30) Foreign Application Priority Data
Mar. 6, 2007 (KR) 10-2007-0021933

(51) Int. Cl. H04L 9/32; G06F 17/00

(52) U.S. Cl. 726/1; 726/4; 726/26

(57) ABSTRACT

A digital rights management (DRM) apparatus in a mobile terminal includes DRM middleware that makes different types of DRM systems compatible. The DRM middleware includes at least one plug-in module to perform a conversion between different types of DRM contents. A part of the at least one plug-in module is downloaded in real time from a server and is executed. A part of the at least one plug-in module is executed by a server by remote control through a plug-in interface.

### CROSS-REFERENCE TO RELATED APPLICATIONS

This application is the National Stage of International Application No. PCT/KR2008/001266, filed Mar. 6, 2008, and claims priority from and the benefit of Korean Patent Application No. 10-2007-0021933, filed on Mar. 6, 2007, which are both hereby incorporated by reference for all purposes as if fully set forth herein.

### BACKGROUND OF THE INVENTION

1. Field of the Invention

The present invention relates to digital rights management (DRM) and, more particularly, to a DRM apparatus in a mobile terminal and a DRM method using the same.

2. Discussion of the Background

As digital content transactions have increased, digital rights management (DRM) technology for software and copyright protection has received increased attention. DRM refers generally to access control technology used by publishers and copyright holders to limit usage of digital media or content, charge for the usage, and distribute and maintain the content. DRM includes digital copyright management technology for allowing only authorized users to use content for a reasonable price, software and security technology for approval and claims of copyright, and payment technology.

Using a DRM system, content is protected when transmitted between network devices in a single system or between network devices in different systems that are in connection with each other. That is, only a network device with a specific security program for DRM can use and exchange the content, and a network device with a different DRM security program may not be able to use and exchange the content.

Korean Patent Application Publication No. 10-2005-1701 discloses the following technology for content compatibility between network devices having different DRM schemes.

FIG. 1 illustrates a traditional DRM system.

The DRM system includes a home network A 100, a home network B 200, a network device A 110 in the home network A 100, a network device B 120 in the home network A 100, a network device C 210 in the home network B 200, a local security program server 130, a remote security program server 500, and a broadcast station 300. The home network A 100, the home network B 200, and the remote security program server 500 are connected to the internet 400.

The DRM system operates as follows:

1) The network device B 120 accesses the home network A 100 if the network device A 110 is connected and operating;

2) Once the network device B 120 is verified according to a predetermined verification process on the home network A 100, the network device A 110 and the network device B 120 exchange DRM security program lists;

3) To use DRM content of the network device A 110, the network device B 120 transmits security program server address information, which is received from the network device A 110, to a local security program server 130 and requests a corresponding DRM security program;

4) The local security program server 130 requests the DRM security program from a remote security program server 500 using the security program server address information;

5) The local security program server 130 receives the DRM security program from the remote security program server 500; and

6) The local security program server 130 transmits the DRM security program to the network device A 110 or the network device B 120, and the network device A 110 or the network device B 120 installs the DRM security program.

Once the DRM security program is installed, the network device A 110 and the network device B 120 may use each other's content.

In brief, network devices using DRM security programs based on different DRM schemes receive and install each other's DRM security programs to use each other's DRM content on the network.

However, since such a conventional technology is based on a personal computer-based network environment, it is difficult for mobile terminals having limited resources to employ the conventional technology. That is, the mobile terminals, such as mobile communication terminals or cellular telephones, Personal Data Assistants (PDAs), and MP3 players typically have a lower memory capacity and a lower operation performance than personal computers, and have different computing performances relative to each other. Therefore, the conventional technology may be difficult to employ in mobile terminals, which may have memory shortages or poor performance upon processing different DRM contents and DRM security programs.

### SUMMARY OF THE INVENTION

The present invention provides a method and system for digital rights management (DRM) for use in a mobile terminal. The method and system are capable of exchanging DRM content using minimum resources without modifying or disclosing core modules of existing DRM systems.

Since the present invention may use plug-in programs such as middleware to perform a conversion procedure between different DRM content by remote control rather than by downloading programs or modules, the present invention can be applied to a mobile terminal-based network environment as well as a personal computer-based network environment.

Additionally, since the conversion procedure between different DRM content/licenses is performed by remote control without modifying or disclosing modules of each DRM system, DRM compatibility is ensured.

Furthermore, the present invention does not require extra equipment, such as a local security program server, thus resulting in reduced cost and resources.

The present invention discloses a digital rights management (DRM) apparatus in a mobile terminal, including DRM middleware that makes different types of DRM systems compatible, where the DRM middleware includes one or more plug-in modules, and a plug-in module may perform a conversion between different types of DRM content.

A part of the plug-in module may be downloaded in real time from a server and may be executed.

A part of the plug-in module may be executed by a server by remote control through a plug-in interface.

The DRM middleware may include: an access control unit including an authentication plug-in and an authorization plug-in to perform authentication of and authorization for the mobile terminal; a content conversion unit including at least one plug-in to convert first DRM content into second DRM content; and a security management unit including at least one plug-in to manage policy between different types of DRM systems and monitor transactions between different types of DRM systems.

The present invention also discloses a digital rights management (DRM) agent in a mobile terminal, including: an access control unit to perform authentication of and authorization for the mobile terminal; a content conversion unit to convert first DRM content into second DRM content; and a security management unit to manage policy between different types of DRM systems and monitor transactions between different types of DRM systems, where at least one module to perform a conversion between different types of DRM contents is defined as a plug-in.

The present invention also discloses a digital rights management (DRM) method using DRM middleware in a mobile terminal, including: if a different type of DRM content is received, executing DRM middleware to make different types of DRM systems compatible; downloading at least one plug-in module constituting the DRM middleware; and converting a different type of DRM content using the downloaded plug-in module, where the DRM middleware includes at least one plug-in module to perform a conversion between different types of DRM contents.

The DRM method may further include executing by remote control a part of a plug-in module constituting the DRM middleware.

The converting of a different type of DRM content may include: authenticating the mobile terminal using an authentication plug-in module; dividing first DRM content into secured content and secured license using an unpackaging plug-in module; analyzing first DRM rights specified in the secured license and translating the secured license into second DRM license; decrypting the secured content using a content encryption/decryption key extracted from the secured license; and packaging the decrypted content and the translated license into second DRM content using a packaging plug-in module.

With the rapid growth of digital content markets, there is great demand for technology related to DRM compatibility. Therefore, the present invention is expected to create significant economic effects upon implementation.

### BRIEF DESCRIPTION OF THE DRAWINGS

FIG. 1 is a schematic diagram of a traditional digital rights management (DRM) system;

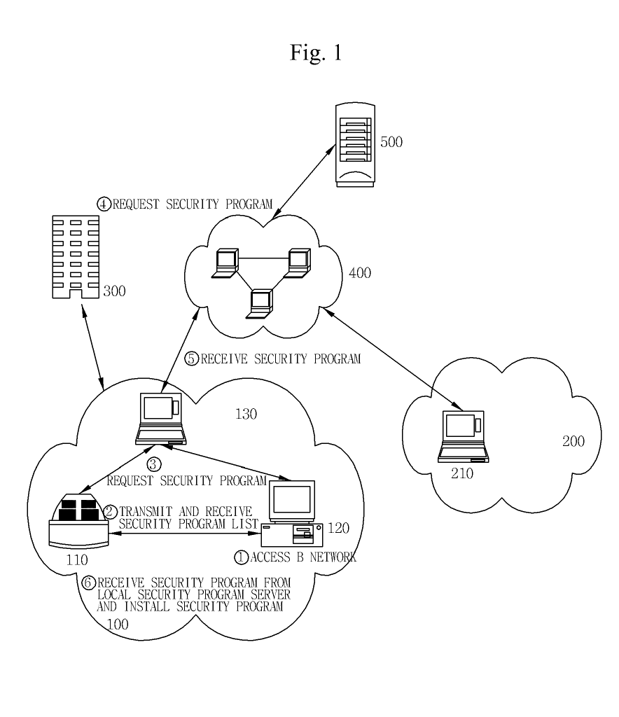

FIG. 2 is a block diagram of a DRM apparatus according to an exemplary embodiment of the present invention;

FIG. 3 is a detailed block diagram of a DRM apparatus according to an exemplary embodiment of the present invention;

FIG. 4 illustrates a plug-in module of a DRM apparatus according to an exemplary embodiment of the present invention;

FIG. 5 illustrates a DRM method according to an exemplary embodiment of the present invention.

FIG. 6 is a flow chart of a DRM method according to an exemplary embodiment of the present invention.

### DETAILED DESCRIPTION OF THE ILLUSTRATED EMBODIMENTS

Hereinafter, exemplary embodiments of the present invention will be described in detail. However, the present invention is not limited to the exemplary embodiments disclosed below, but can be implemented in various ways. Therefore, the present exemplary embodiments are provided for complete disclosure of the present invention and to fully inform the scope of the present invention to those ordinarily skilled in the art.

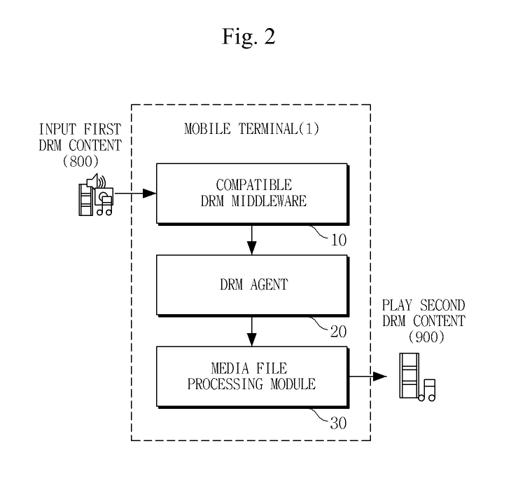

FIG. 2 is a block diagram of a digital rights management (DRM) apparatus according to an exemplary embodiment of the present invention.

A DRM apparatus in a mobile terminal 1 includes compatible DRM middleware 10, a DRM agent 20, and a media file processing module 30. First DRM content/license (hereinafter, first DRM content) 800 is transmitted to the compatible DRM middleware 10 and is converted to second DRM content/license (hereinafter, second DRM content) 900, which is supported by the mobile terminal. Here, the term DRM content/license indicates a combination of coded content and license. The second DRM content 900 is played by the DRM agent 20 and the media file processing module 30.

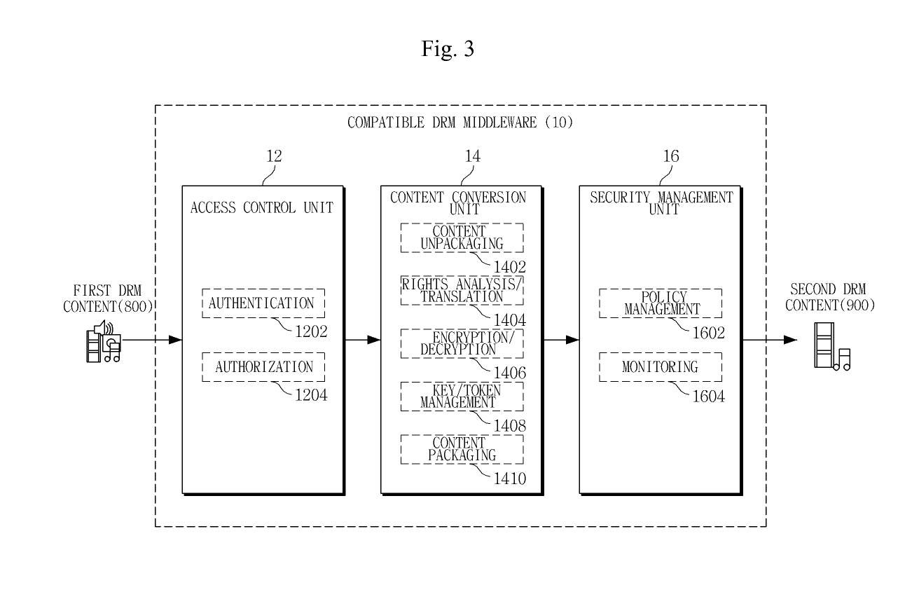

FIG. 3 is a detailed block diagram of a DRM apparatus according to an exemplary embodiment of the present invention.

A module in the DRM middleware 10 for converting DRM content is defined as a plug-in, and the DRM middleware 10 may include many modules. The plug-in may be downloaded in real time. Some of the modules may be performed by remote control via plug-in interface. Accordingly, the DRM middleware 10 is reduced in software size, and different DRM systems are compatible without modifying or disclosing some DRM modules.

In more detail, the DRM middleware 10 includes an access control unit 12, a content conversion unit 14, and a security management unit 16.

The access control unit 12 includes an authentication plug-in 1202 for mutual authentication between the DRM middleware 10 and a user mobile terminal using the DRM middleware 10. The access control unit 12 also includes an authorization plug-in 1204. Authentication is a process that establishes someone or something to be true or genuine. Authentication on a public network including an individual network or internet may be performed by entering a password upon logging in. Authorization is a process that gives someone the power or right to do something. Authorization may include verifying pre-established authority, which may be set by an operator of a system, when a user accesses the system. Authentication logically precedes authorization.

The content conversion unit 14 includes a content packaging plug-in 1410 for conversion between different types of DRM contents, a content unpackaging plug-in 1402, a key/token management plug-in 1408, an encryption/decryption plug-in 1406, and a rights analysis/translation plug-in 1404.

The security management unit 16 includes a policy management plug-in 1602 for managing different policies between DRM systems, and a monitoring plug-in 1604 for monitoring the use of content in a mobile terminal.

As described above, the DRM apparatus in the mobile terminal includes the DRM middleware 10 that makes different DRM systems compatible. The DRM middleware 10 includes at least one module, or plug-in, for conversion between different DRM contents. A part of one module may be downloaded in real time from a server and executed locally, and another part of the module may be executed by the server by remote control through a plug-in interface.

Accordingly, the DRM middleware 10 is reduced in software size. Therefore, exemplary embodiments of the present invention can be applied efficiently to a mobile terminal having limited resources.

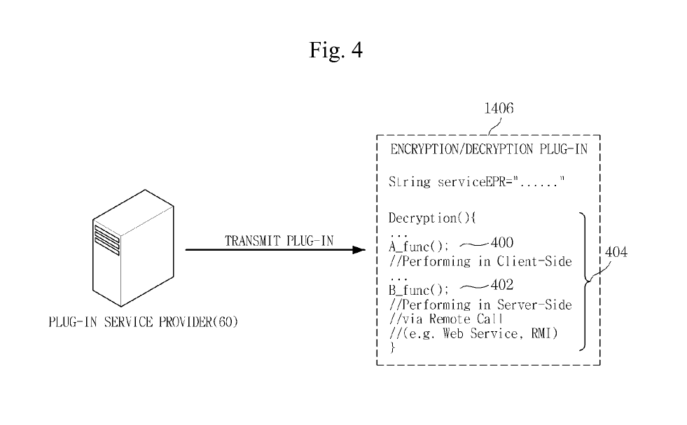

FIG. 4 illustrates a DRM apparatus plug-in module according to an exemplary embodiment of the present invention.

In detail, FIG. 4 illustrates an exemplary embodiment of the encryption/decryption plug-in 1406 from plug-ins in the DRM middleware 10. The encryption/decryption plug-in 1406 may include many encryption/decryption functions 404. Some encryption/decryption functions 400 may be downloaded to a mobile terminal from a plug-in service provider (60) and executed locally, and some encryption/decryption functions 402 may be executed by a server by remote control via a plug-in interface.

If some functions are executed by a server by remote control, the software size of a plug-in may be reduced, thus conserving mobile terminal resources. Additionally, a conversion may be performed between different DRM content without disclosing or modifying modules of each DRM system, thereby making the DRM content compatible. Furthermore, an extra local security program server 130 is not necessary, resulting in reduced cost and resources.

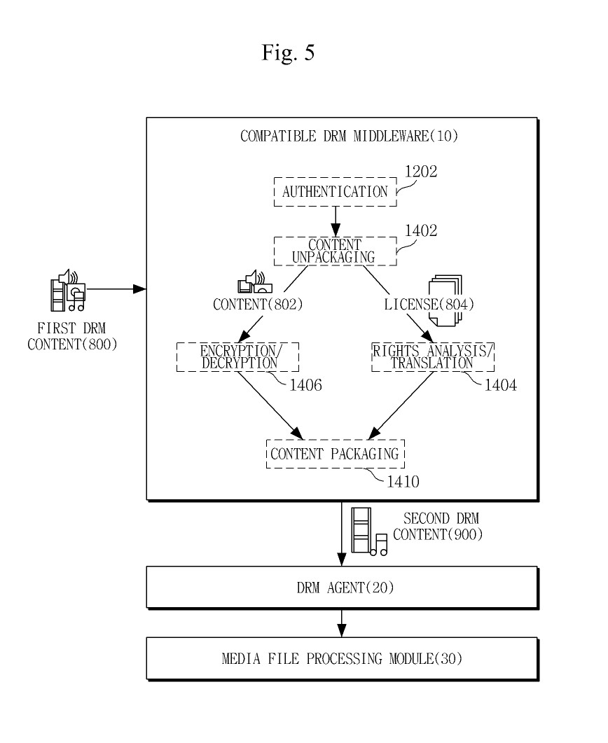

FIG. 5 illustrates a DRM method according to an exemplary embodiment of the present invention.

Referring to FIG. 3 and FIG. 5, if the first DRM content 800 is transmitted to the DRM middleware 10, the first DRM content 800 is handed over to the content conversion unit 14 through the access control unit 12 and is converted to the second DRM content 900. The second DRM content 900 is played through the DRM agent 20 and the media file processing module 30, which are in the mobile terminal. The security management unit 16 communicates with the mobile terminal's operating system and manages and monitors the transactions conducted on the DRM middleware 10. This process will be described below in detail.

1) If the first DRM content 800 is transmitted to the DRM middleware 10, mutual authentication, such as Bluetooth security, between the user mobile terminal and the middleware is performed using the authentication plug-in 1202.

2) Once the mutual authentication is completed, the first DRM content is divided into secured content 802 and secured license 804 using the content unpackaging plug-in 1402. The secured license 804 typically includes a content encryption key (CEK), which is encrypted into a symmetric key to decrypt the secured content 802, and a rights encryption key (REK), which is encrypted into an asymmetric key to decrypt the CEK. Since the REK is encrypted into a mobile terminal's public key, the mobile terminal's private key is needed to decrypt the REK. In this case, after the mutual authentication is completed, the mobile terminal decrypts its REK with its private key and transmits the decrypted REK to the middleware 10.

3) Rights specified in the secured license 804 are analyzed. If the rights are written in a language different from rights expression language (REL) used in the second DRM scheme, the rights are translated into REL of the second DRM scheme by the rights analysis/translation plug-in 1404.

4) The encryption/decryption plug-in 1406 decrypts the secured content 802 using the CEK extracted from the secured license 804. In the secured license 804, the CEK is decrypted with the transmitted REK and is extracted.

The above-described operations 1) to 4) may be performed in the mobile terminal by remote control through the plug-ins. The plug-ins are provided by a plug-in service provider 60 as shown in FIG. 4. Each plug-in records end point reference (EPR) including address information of a remote server so that each module can interface with the remote server and perform functions required for DRM content conversion and remote call. Using this plug-in configuration, modules of the DRM system may be executed locally or by remote control.

5) The decrypted content and the translated rights are packaged into the second DRM content 900 by the content packaging plug-in 1410.

6) The second DRM content 900 converted by the DRM middleware 10 is transmitted to the DRM agent 20 and the media file processing module 30 and is played, executed, or displayed according to the type of the second DRM content 900.

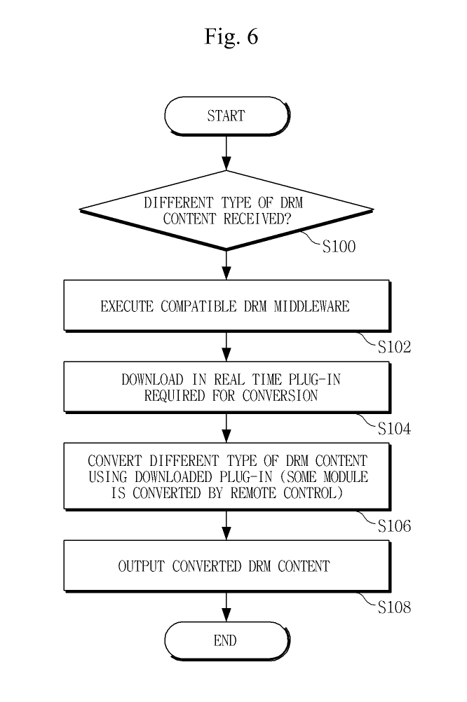

FIG. 6 is a flow chart of a DRM method according to an exemplary embodiment of the present invention.

The DRM method includes the following steps. If a different type of DRM content is received in operation S100, the method includes operating DRM middleware to perform a compatibility process between the different types of DRM systems in operation S102. Then, a plug-in module, which is part of the DRM middleware and is needed for the conversion of the DRM content, is downloaded in real time in operation S104. Next, the different type of DRM content is converted using the downloaded plug-in module in operation S106.

The DRM middleware preferably includes a plug-in module for converting between different types of DRM content. More preferably, the plug-in module may be executed by remote control. The converted DRM content is output in operation S108 and is played in a DRM agent and a media file processing module.

In more detail, operation S106 includes authenticating a mobile terminal using an authentication plug-in module, dividing first DRM content into secured content and secured license using an unpackaging plug-in module, analyzing first DRM rights specified in the secured license and translating the secured license into a second DRM scheme, decrypting the secured content using a content encryption/decryption key extracted from the secured license, and packaging the decrypted content and the translated license into second DRM content using a content packaging plug-in module.

In another exemplary embodiment, the access control unit 12, the content conversion unit 14, and the security management unit 16 of the DRM middleware may be incorporated in the DRM agent 20 in the mobile terminal.

The present invention is applicable to industrial fields on a digital management rights (DRM) method using a DRM apparatus in a mobile terminal.

While the invention has been shown and described with reference to certain exemplary embodiments thereof, it will be understood by those skilled in the art that various changes in form and details may be made therein without departing from the spirit and scope of the invention as defined by the appended claims.

1. A digital rights management (DRM) apparatus in a mobile terminal, comprising DRM middleware that makes different types of DRM systems compatible,
wherein the DRM middleware comprises:
a content conversion unit comprising a first plug-in module to convert first DRM content into second DRM content; and
a security management unit comprising a second plug-in module to manage policy between different types of DRM systems and to monitor transactions between different types of DRM systems.

2. The DRM apparatus of claim 1, wherein a part of the first plug-in module is downloaded in real time from a server and is executed.

3. The DRM apparatus of claim 1, wherein a part of the first plug-in module is executed by a server by remote control through a plug-in interface.

4. The DRM apparatus of claim 1, wherein the DRM middleware further comprises:
an access control unit comprising an authentication plug-in and an authorization plug-in to perform authentication of and authorization for the mobile terminal, respectively.

5. The DRM apparatus of claim 1, wherein the first plug-in module to convert first DRM content into second DRM content is a content packaging plug-in module, and the content conversion unit further comprises a content unpackaging plug-in module, a key/token managing plug-in module, an encryption/decryption plug-in module, and a rights analysis/translation plug-in module to analyze and translate rights between different DRM licenses.

6. The DRM apparatus of claim 1, further comprising a DRM agent to manage second DRM content.

7. A digital rights management (DRM) agent in a mobile terminal, comprising:
an access control unit to perform authentication of and authorization for the mobile terminal;
a content conversion unit to convert first DRM content into second DRM content; and
a security management unit to manage policy between different types of DRM systems and to monitor transactions between different types of DRM systems,
wherein at least one module to perform a conversion between different types of DRM contents is defined as a plug-in module.

8. The DRM agent of claim 7, wherein a part of the plug-in module is downloaded in real time from a server and is executed.

9. The DRM agent of claim 7, wherein a part of the plug-in module is executed by a server by remote control through a plug-in interface.

10. A digital rights management (DRM) method using DRM middleware in a mobile terminal, comprising:
if a different type of DRM content is received, executing DRM middleware to make different types of DRM systems compatible;
downloading at least one plug-in module to the DRM middleware; and
converting a different type of DRM content using the downloaded plug-in module,
wherein the DRM middleware comprises at least one plug-in module to convert between different types of DRM contents, and
wherein converting the different type of DRM comprises:
dividing first DRM content into secured content and secured license using an unpackaging plug-in module;
decrypting the secured content using a content encryption/decryption key extracted from the secured license;
analyzing first DRM rights specified in the secured license and translating the secured license; and
packaging the decrypted content and the translated license into second DRM content using a packaging plug-in module.

11. The DRM method of claim 10, further comprising executing by remote control a part of the downloaded plug-in module.

12. The DRM method of claim 10, wherein the converting the different type of DRM content further comprises:
authenticating the mobile terminal using an authentication plug-in module.
